(19) United States
(12) Patent Application Publication
(10) Pub. No.: US 2026/0141833 A1
(43) Pub. Date: May 21, 2026

(54) TEMPERATURE MANAGEMENT METHOD, INTEGRATED CIRCUIT FOR DISPLAY PANEL AND DISPLAY PANEL

(71) Applicant: NOVATEK MICROELECTRONICS CORP., Hsinchu (CN)

(72) Inventors: Che-Ching Chang, Zhubei (CN); Jen-Hao Liao, Hsinchu (CN)

(21) Appl. No.: 19/219,502

(22) Filed: May 27, 2025

Related U.S. Application Data
(60) Provisional application No. 63/723,544, filed on Nov. 21, 2024.

(30) Foreign Application Priority Data
Feb. 7, 2025 (CN) 202510135428.5

(51) Int. Cl. G09G 3/00; G01K 3/08; G09G 3/3291

(52) U.S. Cl. CPC G09G 3/006; G01K 3/08; G09G 3/3291; G09G 2320/041; G09G 2330/12

(57) ABSTRACT

A temperature management method for a display panel, which is performed by a display driver integrated circuit, and includes: detecting, by the display driver integrated circuit, an impedance value of an edge resistance line of the display panel, wherein the edge resistance line is arranged along the edge of the display panel; and determining, by the display driver integrated circuit, temperature information of the display panel based on the impedance value of the edge resistance line.

### CROSS-REFERENCE TO RELATED APPLICATION

The present disclosure claims the benefit of U.S. Provisional Patent application No. 63/723,544, filed on Nov. 21, 2024, and entitled “TEMPERATURE COMPENSATION METHOD OF DISPLAY PANEL,” and co-pending Chinese Patent Application No. 202510135428.5, filed on Feb. 7, 2025, and entitled “TEMPERATURE MANAGEMENT METHOD, INTEGRATED CIRCUIT FOR DISPLAY PANEL AND DISPLAY PANEL,” the contents of which are incorporated in full by reference herein.

### TECHNICAL FIELD

The present disclosure relates to the field of display panels, and more particularly, to a temperature management method, integrated circuit for a display panel and display panel.

### BACKGROUND

With the rapid development of display technologies, the requirements for a display panel of a terminal device such as a mobile phone or a tablet computer or the like are being increased. In addition to display resolution and color richness, the accuracy of the display effect is also an important index to measure the performance of the display panel. However, the luminous efficiency of a light-emitting element may change due to the influence of temperature, which leads to inconsistency in brightness or contrast or the like of the display panel at different temperatures, resulting in an inaccurate display effect, which in turn affects the user's experience.

Therefore, in order to compensate for the influence caused by the change in temperature, an existing method typically adds hardware such as a temperature sensor to the display panel to perform corresponding temperature detection. However, there are some limitations to such an approach. For example, an additional temperature sensor may increase the cost of the display panel and the complexity of the device, such that the error-tolerant rate of the system is reduced. In addition, with the limitation of the installation position of the temperature sensor, as well as the inaccurate temperature information it provides, the temperature compensation, in turn, cannot be effectively performed.

### SUMMARY

In order to solve at least the above problems, the present disclosure proposes an improved temperature management method for a display panel.

According to a first aspect of the present disclosure, there is provided a temperature management method for a display panel, which is performed by a display driver integrated circuit, including: detecting, by the display driver integrated circuit, an impedance value of an edge resistance line of the display panel, in which the edge resistance line is arranged along the edge of the display panel; and determining, by the display driver integrated circuit, temperature information of the display panel based on the impedance value of the edge resistance line. According to an embodiment of the present disclosure, the temperature management method further includes: performing, by the display driver integrated circuit, temperature compensation on the display panel based on the determined temperature information.

According to a second aspect of the present disclosure, there is provided an integrated circuit for a display panel, including: a processing circuit; and a memory having stored computer program instructions therein, in which the computer program instructions, when executed by the processing circuit, cause the integrated circuit to perform the temperature management method according to the first aspect of the present disclosure.

According to a third aspect of the present disclosure, there is provided a display panel, including: an edge resistance line, arranged along the edge of the display panel; and the integrated circuit according to the second aspect of the present disclosure, coupled to the edge resistance line.

According to a fourth aspect of the present disclosure, there is provided a terminal device, including the display panel according to the third aspect of the present disclosure.

According to the above various aspects of the present disclosure, by utilizing an existing hardware configuration in a display panel to perform temperature detection, not only additional cost and complexity of display panel can be avoided, but also more accurate temperature information can be provided, such that it is beneficial to subsequent temperature management method such as temperature compensation.

### BRIEF DESCRIPTION OF DRAWINGS

The advantages of various aspects of the present disclosure will become clearer and easier to understand from the following detailed description of the embodiments of the present disclosure with reference to the accompanying drawings, in which:

FIG. 1 is a schematic diagram showing an example pixel circuit of a display panel according to an embodiment of the present disclosure;

FIG. 2 shows current-voltage curves of a display panel respectively under normal temperature condition and low temperature condition according to an embodiment of the present disclosure;

FIG. 3 is a schematic diagram showing a heat generation situation of a display panel according to an embodiment of the present disclosure;

FIG. 4 is an overall flowchart showing a temperature management method according to an embodiment of the present disclosure;

FIG. 5 shows an example method of detecting an impedance value of an edge resistance line based on a voltage value according to an embodiment of the present disclosure;

FIG. 6 shows an example method of detecting an impedance value of an edge resistance line based on a current value according to an embodiment of the present disclosure;

FIG. 7 is an example showing the optimal display parameters in different temperature intervals according to an embodiment of the present disclosure;

FIG. 8 is an example showing grayscale-data voltage curves under different temperature conditions according to an embodiment of the present disclosure; and

FIG. 9 is a schematic diagram showing a display panel according to an embodiment of the present disclosure.

### LIST OF REFERENCE NUMERALS

T1: Selecting TFT
T2: Driving TFT
C: Capacitor
OLED: Light-Emitting Diode
Vgate: Gate voltage of T1
V source: Source voltage
V_{gs}: Driving voltage of OLED
Vₜₕ: Threshold voltage of OLED
I_{d}: Driving current of OLED
ELVDD: Anode voltage of display panel
ELVSS: Cathode voltage of display panel
I_{det}: Detecting current
Iₘₑₐ: Measuring current
V_{det1}, V_{det2}: Detecting voltage
Vₘₑₐ: Measuring voltage
R_{PE}: Impedance value of edge resistance line
300, 900: Display panel
301: Temperature sensor
302: Display driver integrated circuit
901: Edge resistance line
902: Integrated circuit
9021: Processing circuit
9022: Memory

### DETAILED DESCRIPTION

A detailed illustration is made to the present disclosure with the accompanying drawings and the detailed description. It should be understood that based on the embodiments described in the present disclosure, all other implementations obtained by those skilled in the art without paying creative labor should fall within the protection scope of the present disclosure, and the embodiments as described herein are only part of the embodiments of the present disclosure, not all of the embodiments of the present disclosure. These embodiments are merely illustrative and exemplary, and thus should not be interpreted as limiting the scope of the present disclosure.

In order for a clear and complete clarification of the technical concept of the present disclosure, firstly, taking an Organic Light-Emitting Diode (OLED) panel as an example, a light emitting principle of pixels of a display panel is explained with reference to FIG. 1. It should be understood that the technical solution involved in the present disclosure can also be applied to other types of the display panel such as an ordinary LED panel, a micro-LED panel, a quantum dot LED, or a Liquid Crystal Display (LCD).

Specifically, FIG. 1 shows a schematic diagram of an example pixel circuit of a display panel according to an embodiment of the present disclosure. As shown in FIG. 1, each pixel in the OLED panel may be driven by a circuit containing at least one of the Thin Film Transistors (hereinafter referred to as TFT). For example, in the 2T1C pixel circuit (with 2 TFTs and 1 capacitor) as shown in FIG. 1, T1 is a selecting TFT, T2 is a driving TFT, C is a capacitor, OLED is a light-emitting diode, ELVDD and ELVSS are the anode and cathode voltage of the display panel respectively. When a pixel is determined to be lightened, T1 in the corresponding pixel circuit is first turned on by its gate voltage Vgate, such that a source voltage V_{Source} is applied to the gate of T2. After T1 is turned off, T2 maintains an on state due to the voltage on the gate of T2 held by C, resulting in a voltage V_{gs} across the gate and the source of T2, and applied to the anode of the OLED to generate a current I_{d} flowing through the OLED, such that the OLED is turned on and emits light. The brightness of the light emitted by the OLED depends on the power of the OLED, that is, I_{d}×Vₜₕ. Therefore, in general, the greater the current I_{d} is, the higher the brightness of the light emitted by the OLED is. The current I_{d} flowing through the OLED can be expressed as:

$${I}_{d} = {K ( {V}_{gs} - {V}_{th} )}^{2} = {K ( E L V D D - {V}_{source} - {V}_{th} )}^{2} \qquad Formula 1$$

where I_{d} represents the current flowing through the OLED; K represents a factor related to the conductive characteristics of the TFT, which is related to the physical structure and the material characteristics of the TFT, and can be regarded as a constant; V_{gs} represents the voltage across the gate and the source of T2, which corresponds to the driving voltage of the OLED; Vₜₕ represents a threshold voltage of the OLED, which corresponds to the lowest voltage at which OLED is turned on; ELVDD represents the anode voltage of the OLED panel, which may be provided by the voltage source of the panel; and V_{source} represents the source voltage of the panel, which may be provided by a driving circuit of the panel, such as a display driver integrated circuit described in detail below. It can be seen from the above Formula 1 that the current I_{d} can be adjusted by adjusting parameters such as V_{source} or V_{gs}, such that the adjustment of the brightness of the light emitted by the OLED is realized.

However, as described above, the luminous efficiency of the display panel will be changed by the change in temperature. For example, depending on the utilized material, the conductive characteristics of the panel elements will change with the change in temperature, which leads to a change in the threshold voltage Vₜₕ of the OLED, such that even if the same V_{gs} is used to drive the OLED, the current I_{d} flowing through the OLED will be different at different temperatures, resulting in discrepancies in the brightness of the light emitted by the OLED at different temperatures.

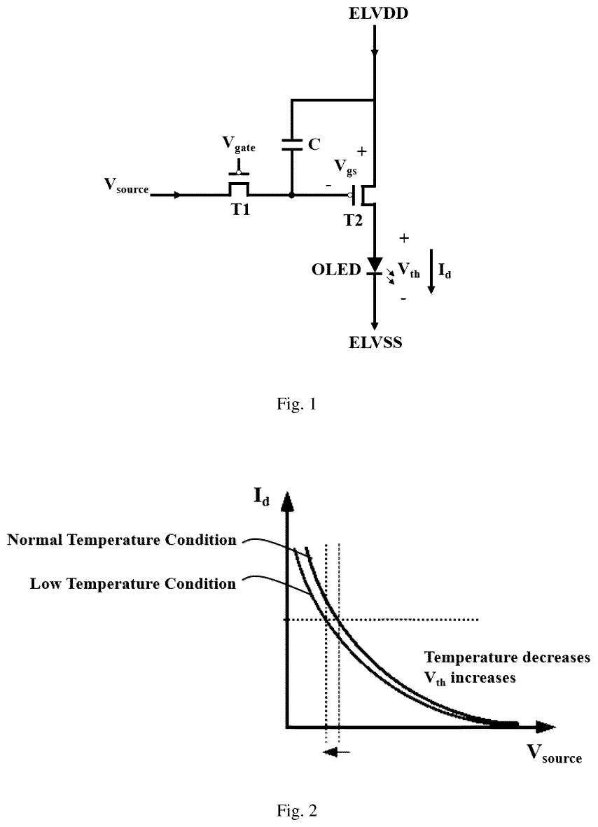

Specifically, FIG. 2 shows I_{d}-V_{source} curves of a display panel respectively under normal temperature condition and low temperature condition, where the solid line on the right side represents the I_{d}-V_{source} curve under normal temperature condition and the solid line on the left side represents the I_{d}-V_{Source} curve under low temperature condition. As shown in FIG. 2, compared with the normal temperature condition (e.g., 25° C.), under the low temperature condition (e.g., 5° C.), since the threshold voltage Vₜₕ of the OLED increases, a higher driving voltage V_{gs} is needed for the OLED to turn on and emit light. If the source voltage V_{source} and the voltage of ELVDD provided under low temperature condition are kept unchanged, then there will be insufficient driving voltage V_{gs} to generate the same current I_{d}, which will lead the OLED to fail to reach the expected level of brightness under normal temperature condition, or even fail to light the pixel, resulting in the above-mentioned problem of inaccurate display effect.

Therefore, there is a need in the art for a method capable of accurately detecting the temperature of a display panel, such that corresponding processing of temperature compensation can be performed according to the temperature of the display panel to guarantee the accuracy of the display effect of the panel.

For this reason, some existing display panels may be equipped with an additional temperature sensor to implement the above temperature management method, such as temperature detection and temperature compensation. However, as described above, with such a configuration, not only is the cost and the complexity of the system increased, but also the temperature information provided by the temperature sensor is inaccurate. For example, since the heat generation by the display panel (especially the OLED panel) embodies locality, the temperature information detected by the temperature sensor might vary depending on its installation position, which means that the temperature sensor arranged at a specific position might not accurately reflect the temperature status of the entire panel.

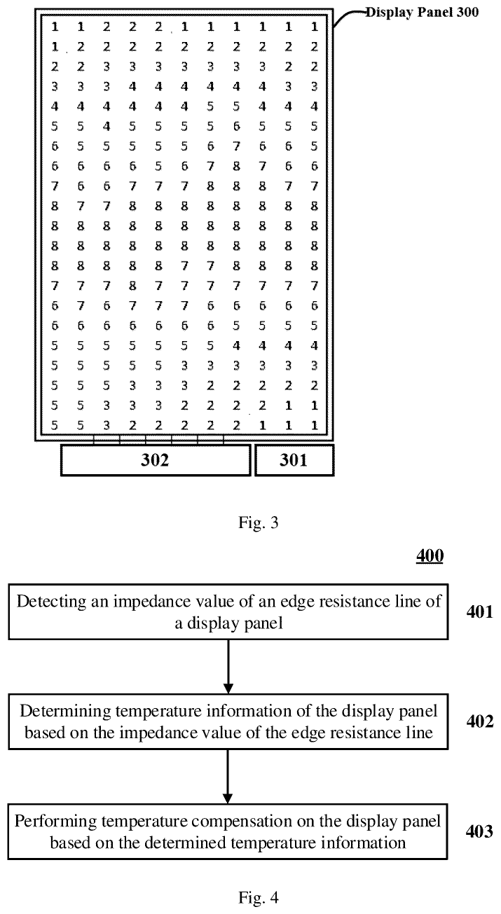

FIG. 3 shows such a situation. As shown in FIG. 3, a display panel 300 may include a temperature sensor 301 and a display driver integrated circuit (DDIC) 302. The actual temperatures of respective sub-regions of the display panel 300 are expressed by different numerical values (1 to 8), where a higher numerical value means a higher temperature. It can be seen that the temperature of the region in the middle of the display panel is significantly higher than that of the regions at the top and the bottom (especially the lower right) of the display panel. Therefore, when the temperature sensor 301 is installed near the lower right of the display panel, its measured temperature (the corresponding numerical value of which is about 1.45) will be significantly lower than the average temperature of the display panel (the corresponding numerical value of which is about 4.99), such that the temperature information of the display panel cannot be provided, and in turn the correct temperature compensation cannot be performed.

With respect to the above problem, the present disclosure proposes to utilize an edge resistance line that was originally used for Panel Crack Detection (hereinafter referred to as PCD) to perform a temperature management method (such as temperature detection and temperature compensation) for the display panel, such that more accurate temperature information is provided without adding additional hardware, which improves the existing temperature management method for the display panel.

Specifically, in the field of display technologies, PCD may be used to check whether there is a crack during the production of the display panel (such as damage due to the cutting procedure), so as to improve the yield and the quality of the product. In order to perform the above PCD, the panel manufacturer typically arranges a resistance line (i.e., edge resistance line) along the edge of the display panel, and checks cracks in the display panel by detecting the impedance value of the resistance line. If the detected impedance value of the edge resistance line is within a reasonable range, it indicates that the peripheral edge of the display panel is complete, and it can be considered that there is no crack in the display panel. However, if the detected impedance value is far beyond the reasonable range, it indicates that there is an open in the loop formed by the edge resistance line, meaning that a gap or break might probably occur in the peripheral edge of the display panel, and it can be considered that there is a crack in the display panel.

On this basis, the inventors have recognized that there is a good correlation between the impedance value of the edge resistance line arranged along the edge of the display panel and the temperature of the display panel. Accordingly, not only can the edge resistance line in the display panel proposed in the present disclosure be used for PCD, but also its impedance value can act as an effective medium to reflect the change in temperature of the display panel, such that it can be used in the temperature management method.

Various embodiments of the temperature management method according to the present disclosure will be described in detail below in conjunction with FIGS. 4 to 8.

### (Implementation 1)

FIG. 4 is an overall flowchart showing a temperature management method according to an embodiment of the present disclosure. As shown in FIG. 4, method 400 can be performed by a Display Driver Integrated Circuit (DDIC), and includes:

Step S401: Detecting an impedance value of an edge resistance line of a display panel.

According to the embodiment of the present disclosure, the method for detecting the impedance value of the edge resistance line by the DDIC may include a voltage detection-based or current detection-based approach.

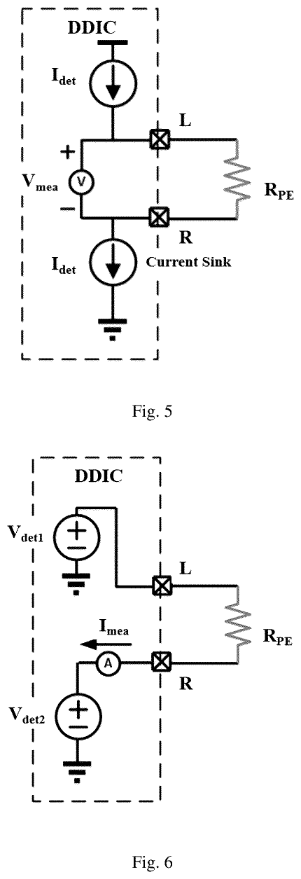

FIG. 5 shows an example method of detecting the impedance value of an edge resistance line based on a voltage value (or based on current driving) according to an embodiment of the present disclosure. As shown in FIG. 5, R_{PE} represents the equivalent resistance of the edge resistance line arranged along the edge of the display panel, and the edge resistance line is coupled to the display driver integrated circuit of the display panel. For example, a current source can be provided by the DDIC to offer a constant detecting current I_{det} at one end L of the edge resistance line, a current sink is set for absorbing the detecting current I_{det} at the other end R, and the voltage value Vₘₑₐ between both ends L and R of the edge resistance line is measured, such that the impedance value R_{PE} of the edge resistance line can be obtained by Ohm's law, as follows:

$${R}_{PE} = \frac{{V}_{mea}}{{I}_{det}} \qquad Formula 2$$

FIG. 6 shows an example method of detecting an impedance value of an edge resistance line based on a current value (or based on voltage driving) according to an embodiment of the present disclosure. The main difference between FIG. 6 and FIG. 5 is that, as shown in FIG. 6, a constant detecting voltage V_{det1} is provided by the DDIC at one end L of the edge resistance line, and another constant detecting voltage V_{det2} is provided at the other end R. Therefore, the voltage value between both ends L and R of the edge resistance line can be obtained, and the current value Iₘₑₐ flowing through the edge resistance line can be measured, such that the impedance value R_{PE} of the edge resistance line can be obtained by Ohm's law, as follows:

$${R}_{PE} = \frac{{V}_{det 1} - {V}_{det 2}}{{I}_{mea}} \qquad Formula 3$$

In the embodiment of the present disclosure, the impedance value of the edge resistance line can be the impedance value itself determined according to the above solution, or other forms of numerical value information converted according to a predetermined rule (.e.g., the impedance value can be expressed in the form of a code).

Step S402: Determining temperature information of the display panel based on the impedance value of the edge resistance line.

As described above, the inventor has recognized that there is a good correlation between the impedance value of the edge resistance line and the temperature of the display panel. For example, it can be found through experiments that when the temperature of the display panel is 38° C., the detected impedance value of the edge resistance line is about 231 kiloohms (K (2). Subsequently, a cooling processing is performed on the display panel, such that the temperature of the display panel drops to 36° C., at which time the detected impedance value of the edge resistance line is about 219 KΩ. Subsequently, the display panel is left to rest for some time, and then the temperature of the display panel rises back to 37° C., at which time the detected impedance value of the edge resistance line is about 225 KΩ. It can be seen that in this example, there is an approximate linear relationship between the impedance value of the edge resistance line and the temperature of the display panel. Therefore, with such a correlation, the temperature information of the display panel can be determined by the DDIC based on the detected impedance value of the edge resistance line. Additionally, depending on the type of display panel, there might be a nonlinear relationship between the impedance value of the edge resistance line and the temperature of the display panel. In this case, the temperature information corresponding to the impedance value of the edge resistance line can also be determined by means of the correlation.

In addition, since the edge resistance line is arranged along the circumferential direction of the display panel and is adjacent to the body of the panel, such an arrangement approach makes the temperature information determined based on the impedance value of the edge resistance line better reflect the overall temperature status of the display panel. For example, in the case of the display panel as shown in FIG. 3, with the temperature detection method of the present disclosure, the numerical value corresponding to the temperature determined based on the edge resistance line is about 3.98, which is closer to the average temperature of the display panel (the corresponding numerical value of which is about 4.99), and provides more accurate temperature information than the temperature sensor.

In addition, according to the embodiment of the present disclosure, for step S402, the determining of the temperature information of the display panel based on the impedance value of the edge resistance line may include: comparing, by the DDIC, the impedance value of the edge resistance line with a reference impedance value; and determining the temperature information of the display panel based on the comparing.

Specifically, the reference impedance value for the comparison may correspond to an impedance value of the edge resistance line detected at a reference temperature, where the reference temperature can be a known temperature, or a temperature of the display panel in a conventional state. For example, while performing PCD on the display panel, it is required to detect the impedance value of the edge resistance line of the display panel, and the display panel is typically in a constant temperature condition (e.g., normal temperature environment) during the PCD. Therefore, when the display panel is confirmed to be qualified through the PCD, the impedance value of the edge resistance line detected through the PCD may be incidentally recorded as the reference impedance value, and for example, burned, in the form of code (such as PCD code), into the DDIC of the display panel, or a storage module such as flash memory. While performing the temperature management method according to the present disclosure, since the reference impedance value corresponds to the reference temperature of the display panel (e.g., 25° C.), the change or difference of the temperature of the display panel relative to the reference temperature may be learned by comparing the reference impedance value with the currently detected impedance value, such that the temperature information of the display panel is determined, (for example, whether the temperature of the display panel is in a rising/dropping trend, the display panel being in a high/low temperature condition, or the specific temperature value of the display panel), and accordingly the corresponding temperature management is performed.

In this embodiment, since the impedance value of the edge resistance line of the display panel is originally required to be detected during the PCD, the temperature management method of the present disclosure is only required to record an impedance value corresponding to a case of being qualified in the PCD as a reference value corresponding to a specific reference temperature, without adding an additional impedance detection flow, which will not affect or burden the established production flow.

Alternatively, according to the embodiment of the present disclosure, for step S402, the determining of the temperature information of the display panel based on the impedance value of the edge resistance line may include: determining, by the DDIC using a pre-generated temperature-impedance mapping relationship, the temperature information of the display panel based on the impedance value of the edge resistance line.

Specifically, for example, the impedance value of the edge resistance line and the corresponding temperature of the display panel may be generated as a temperature-impedance mapping relationship table, such that the temperature information can be determined by looking up the temperature of the display panel corresponding to the currently detected impedance value. For example, the resistance value of the edge resistance line of the display panel may be detected by the DDIC respectively at different temperatures to obtain a plurality of (at least two) resistance values corresponding to the different temperatures. Then, based on the at least two impedance values and their corresponding temperatures, the DDIC may generate a relationship between the impedance value of the edge resistance line and the temperature of the display panel, for example by means of interpolation, function fitting or the like, so as to obtain a temperature-impedance mapping relationship table. According to the embodiment of the present disclosure, the temperature-impedance mapping relationship may also be expressed in the form of a corresponding function, graph, or the like.

As shown in Table 1 below, when the temperature of the display panel is 25° C., a first impedance value of the edge resistance line is detected to be 300K ohms (the corresponding PCD code value of which is 30), and when the temperature of the display panel is 40° C., a second impedance value of the edge resistance line is detected to be 370K ohms (the corresponding PCD code value of which is 37). Assuming that for this kind of display panel, there is a linear relationship between the impedance value of the edge resistance line and the temperature of the display panel, then the estimated temperature corresponding to any impedance value within a certain range can be obtained by linear interpolation, so as to generate a temperature-impedance mapping relationship, as shown in Table 2 below.

TABLE 1

| Impedance Value (PCD code) | Temperature of Display Panel (° C.) |
|---|---|
| 30 | 25 |
| 37 | 40 |

TABLE 2

| Impedance Value (PCD code) | Temperature of Display Panel (° C.) |
|---|---|
| . . . | . . . |
| 18 | −0.714 |
| 19 | 1.429 |
| . . . | . . . |
| 28 | 20.714 |
| 29 | 22.857 |
| 30 | 25 |
| 31 | 27.143 |
| 32 | 29.286 |
| . . . | . . . |
| 37 | 40 |
| 38 | 42.143 |
| 39 | 44.286 |
| . . . | . . . |

Therefore, while performing the temperature management method according to the present disclosure, the temperature information of the display panel can be determined based on the impedance value of the edge resistance line using the generated temperature-impedance mapping relationship.

Additionally, since the magnitudes of the intrinsic impedance values of the edge resistance lines of different display panels are different, the impedance values at the same temperature are correspondingly different, and the degree of the change with temperature might also be different, a standardization processing may be performed on the edge resistance lines of the different display panels, such that the impedance values of the different display panels at the reference temperature (e.g., 25° C.) correspond to a same numerical value. For example, regardless of the intrinsic impedance values of the edge resistance lines of the display panels, the impedance values (in the form of PCD code value) at 25° C. are uniformly defined as 100, and the impedance values corresponding to other temperatures are scaled correspondingly to obtain standardized impedance values. Alternatively, a segmented function representing the temperature-impedance mapping relationship may further be fitted for different temperature intervals. For example, the temperature-impedance relationship in a low temperature interval can be fitted as a first linear function, and the temperature-impedance relationship in a high temperature interval can be fitted as a second linear function with a different slope, or other types of functions such as a nonlinear function.

In this embodiment, considering that the edge resistance lines of different types of display panels might be different with the change in temperature, the corresponding temperature-impedance mapping relationship may also vary depending on the type of display panel. Therefore, the DDIC may generate a temperature-impedance mapping relationship specific to the display panel based on multiple impedance value detections at different temperatures. In this way, compared with the method using a simple comparison of numerical values, the temperature information determined using the temperature-impedance mapping relationship is more accurate.

In addition, according to the embodiment of the present disclosure, the above procedure of generating a temperature-impedance mapping relationship may be introduced into the production flow for the display panel. For example, during the PCD for the display panel, at least two impedance values corresponding to different temperatures are detected for each display panel, and a temperature-impedance mapping relationship may be generated based on such data, and be stored in the display panel, for characterizing the temperature-impedance relationship specific to the display panel. Since the detection of impedance value is typically involved in the production flow for the display panel, the above procedure may not burden the production flow for the display panel, and can further provide a basis for the display panel to possess an ability of temperature detection, such that whenever the display panel needs to perform any temperature-related processing (such as temperature compensation, temperature display or other temperature information based operation), corresponding temperature information can be provided based on the pre-stored temperature-impedance mapping relationship.

In addition, according to the embodiment of the present disclosure, the above temperature detection method can also be performed by the DDIC based on different regions of the display panel.

For example, for step S401, a plurality of segmental impedance values of different segments of the edge resistance line of the display panel may be further detected by the DDIC, where different segments correspond to different regions of the display panel. Correspondingly, for step S402, the temperature information of different regions of the display panel can be determined by the DDIC based on the detected plurality of segmental impedance values.

Specifically, at the edge of the display panel, a plurality of segments of an edge resistance line are arranged along the circumferential direction, where each segment corresponds to a specific region of the display panel. For example, the entire edge resistance line may be divided into four quadrants, the resistance line of each quadrant being regarded as a segment, to correspond to four regions, the upper left, the upper right, the lower left, and the lower right of the display panel. Then, the respective segments of the edge resistance line may be connected through the DDIC, and the impedance value of each segment of the edge resistance line may be detected respectively with the method described above. Assuming that the detected impedance value of the resistance line segment corresponding to the upper left region is R1, the impedance value of the resistance line segment corresponding to the upper right region is R2, the impedance value of the resistance line segment corresponding to the lower left region is R3, and the impedance value of the resistance line segment corresponding to the lower right region is R4. On this basis, with the plurality of segmental impedance values of the different segments, the corresponding temperature information of different regions of the display panel can be determined according to the comparison with the reference impedance value or using the pre-generated temperature-impedance mapping relationship.

Through this embodiment, the temperature detection of different regions of the display panel can be realized, such that for some display panel types whose heat generation embodies locality, the situation where the display panel generates heat at different ambient temperatures or locally can be effectively coped with, such that it is more conducive to the temperature management, for example, regional temperature compensation can be performed based on the temperature detection in different regions of the display panel.

Implementation 1 of the temperature management method according to the present disclosure has been described above, that is, a method of performing temperature detection utilizing the impedance value of the existing edge resistance line in the display panel.

### (Implementation 2)

According to another embodiment of the present disclosure, as shown in FIG. 4, method 400 further includes:

Step 403: Performing temperature compensation on the display panel based on the determined temperature information.

Specifically, in order to compensate for the difference in luminous efficiency due to the change in temperature, at least one of parameters related to the display effect of the display panel, such as a source voltage V_{source}, a cathode voltage ELVSS, an anode voltage ELVDD, an initialization positive voltage VINITP, an initialization negative voltage VINITN, a high gate voltage VGH or a low gate voltage VGL of the display panel, may be adjusted by the DDIC based on the temperature information determined according to the above steps.

In an example, assuming that a reference impedance value (in the form of PCD code value) of the display panel at a reference temperature (e.g., 25° C.) is 100, if the currently detected impedance value is 138, the corresponding situation is that the current temperature of the display panel is higher than 25° C., at which time the absolute value of the cathode voltage ELVSS of the display panel can be reduced (e.g., through the control by the DDIC), such that the driving voltage V_{gs} of the OLED is reduced; or if the currently detected impedance value is 64, the corresponding situation is that the current temperature of the display panel is lower than 20° C., at which time the absolute value of the cathode voltage ELVSS of the display panel can be increased, such that the driving voltage V_{gs} of the OLED is increased. In this way, a dynamic temperature compensation can be performed simply according to the changing trend of the temperature of the display panel relative to the reference temperature, such that the luminous efficiencies of the display panel at different temperatures are basically consistent.

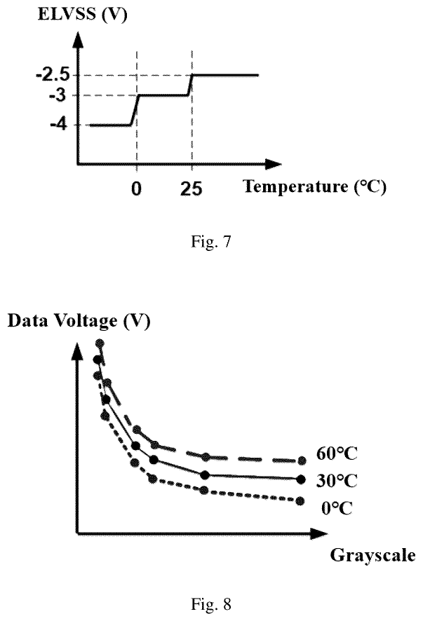

Alternatively, optimal settings of the display panel corresponding to different temperature intervals may be further recorded for the DDIC to perform the temperature compensation. FIG. 7 shows examples of optimal display parameters in different temperature intervals according to an embodiment of the present disclosure. For example, the following optimal display parameters may be obtained according to experiments: when the temperature of the display panel is above 25° C., the cathode voltage ELVSS should be −2.5V; when the temperature of the display panel is between 0° C. and 25° C., the ELVSS should be −3V; and when the temperature of the display panel is below 0° C., the ELVSS should be −4V. On this basis, the above optimal settings in different temperature intervals may be stored in the display panel for temperature compensation, such that the display panel can use suitable parameters for temperature compensation according to the temperature interval where it is. Additionally, the above example describes the temperature compensation approach only for illustrative purposes. It can be understood by those skilled in the art that depending on the electronic elements used in the display panel, the specific approaches of temperature compensation may vary depending on the display panel. For example, besides the cathode voltage ELVSS, any parameter or parameter combination of the source voltage V_{Source}, the anode voltage ELVDD, the initialization positive voltage VINITP, the initialization negative voltage VINITN, the high gate voltage VGH or the low gate voltage VGL of the display panel may be adjusted, and the adjustment logic for the same parameter might be different, depending on the connection approach of the electronic elements.

In addition, according to the embodiment of the present disclosure, the adjusting of the at least one of parameters of the display panel based on the determined temperature information may further include: adjusting, by the DDIC, at least one of the parameters of the display panel using a temperature compensation curve corresponding to the determined temperature information, in which the temperature compensation curve is determined based on at least two preset temperature compensation curves for different temperatures.

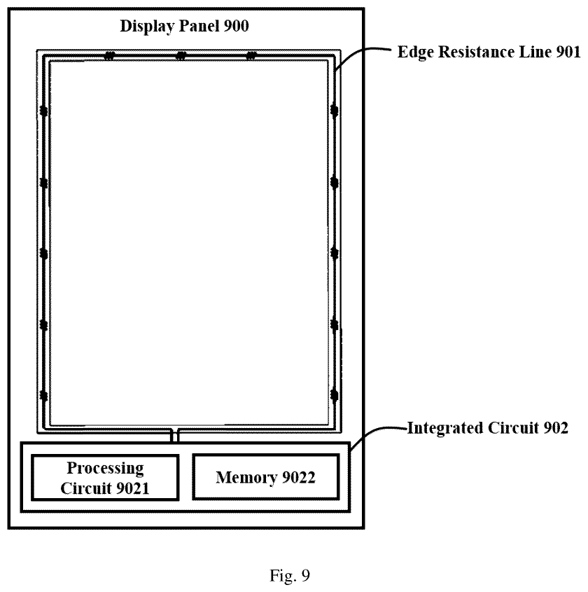

Specifically, a plurality of groups of temperature compensation curves may be preset according to the temperature characteristics of the panel material and the design requirements of the display panel. For example, for the grayscale of the display panel, grayscale-data voltage curves of the display panel at different temperatures may be pre-configured, and such curves correspond to optimal display performances of the display panel at corresponding temperatures, respectively. FIG. 8 shows an example of grayscale-data voltage curves under different temperature conditions according to an embodiment of the present disclosure. As shown in FIG. 8, assuming that the grayscale-data voltage (e.g., corresponding to the V_{Source} in FIG. 1) curves of the display panel at low temperature (e.g., 0° C.) and high temperature (e.g., 60° C.) conditions are pre-configured, both curves correspond to the optimal values of the data voltage for the grayscale from low to high of the display panel at 0° C. and 60° C., respectively. With a method of linear interpolation, a numerical value between two known data points can be predicted. For example, for each grayscale, the corresponding data voltage value of the display panel at 30° C. can be calculated by linear interpolation, and the calculated data voltage values corresponding to respective grayscales are combined, such that a grayscale-data voltage curve corresponding to 30° C. can be obtained. By analogy, any temperature compensation curve within a certain temperature interval can be determined based on at least two preset temperature compensation curves, for performing the temperature compensation. For example, when the temperature corresponding to the impedance value is detected to be 25° C., the current temperature compensation curve at 25° C. can be calculated based on the preset temperature compensation curves for 0° C. and 30° C., and the data voltage value corresponding to the desired grayscale can be set according to the temperature compensation curve.

In addition, as described above, in the embodiment of the present disclosure, the above temperature detection method may be performed by the DDIC based on different regions of the display panel, and correspondingly, while performing temperature compensation on the display panel, the temperature compensation may be performed on the display panel by the DDIC based on the temperature information of different regions. Therefore, a regional temperature compensation can be performed on the display panel, so as to achieve a better display effect.

Implementation 2 of the temperature management method according to the present disclosure has been described above, that is, a method of performing temperature compensation utilizing the impedance value of the existing edge resistance line in the display panel.

Additionally, the temperature information may be used not only for the temperature compensation of the display panel but also for other operations. For example, the temperature information may be provided to a processor outside the display panel (such as a processor of a device) for controlling system-level operations. According to the embodiment of the present disclosure, power management, heat dissipation management, or processor mode management may be performed on the terminal device based on the temperature information.

In addition, according to the embodiment of the present disclosure, the above temperature management method may be performed automatically and periodically, or in response to an instruction from a processor. For example, the DDIC of the display panel may perform the above temperature detection or temperature compensation once every predetermined number of frames or predetermined time, or trigger the performing of the above temperature detection or temperature compensation in response to an instruction from the processor of the display panel. Alternatively, some or all of the steps in the above temperature management method may also be performed by the processor of the display panel or the terminal device.

The temperature management method according to the present disclosure has been described above, which utilizes the existing hardware configuration in the display panel, for example, the edge resistance line that was originally used for panel crack detection, to perform the temperature management method of the display panel (including such as temperature detection and temperature compensation and the like), such that more accurate temperature information is provided without adding additional hardware, which improves the existing temperature management method for the display panel.

Next, an integrated circuit for a display panel and an example of a display panel including the integrated circuit according to an embodiment of the present disclosure are described in conjunction with FIG. 9.

FIG. 9 is a schematic diagram showing a display panel according to an embodiment of the present disclosure. As shown in FIG. 9, a display panel 900 includes an edge resistance line 901 arranged along the edge of the display panel, and an integrated circuit 902 coupled to the edge resistance line 901.

In the embodiment of the present disclosure, the edge resistance line can broadly refer to the resistance element arranged in the edge region of the display panel. For example, it can be a detecting resistance for PCD or a resistance line arranged along the circumferential direction of the peripheral edge of the display panel for other purposes. As shown in FIG. 9, the edge resistance line can be a resistance loop line arranged along the edge of the panel, which can be a resistance line, or a plurality of resistance lines connected in series, or a plurality of segmented independent resistance lines. Moreover, depending on the form of the display panel, the edge resistance line may be arranged along the edge or part of the edge of the panel. Additionally, the integrated circuit 902 can be implemented by the above display driver integrated circuit (DDIC), and the integrated circuit 902 further includes a processing circuit 9021 and a memory 9022 having stored computer program instructions therein, in which the computer program instructions, when executed by the processing circuit 9021, can cause the integrated circuit 902 to perform the temperature management method described above in conjunction with FIGS. 1 to 8, which is not detailed herein.

In addition, in other examples, the integrated circuit 902 according to the embodiment of the present disclosure may be an independent component outside the display panel 900.

In addition, in other examples, the integrated circuit 902 according to the embodiment of the present disclosure may perform at least part of the steps of the above temperature management method. For example, the integrated circuit 902 may only perform the temperature detection method, and provide the temperature information to a processor (such as a processor of a terminal device), for the processor to perform the temperature compensation or other temperature management methods.

In addition, the present disclosure can further provide a terminal device including the display panel according to the embodiment of the present disclosure. For example, such terminal devices can include smartphones, televisions, electronic picture frames, tablet computers, notebook computers, and the like. According to the embodiment of the present disclosure, the terminal device may further include a processor configured to: receive the temperature information determined according to the method of the embodiment of the present disclosure; and control an operation of the terminal device based on the temperature information. For example, at least one of power management, heat dissipation management, or processor mode management may be performed on the terminal device based on the temperature information.

In addition, the present disclosure can further provide a computer-readable storage medium having stored computer instructions therein, and a computer program product including the computer instructions, in which the computer program instructions, when executed by a processor, implement the temperature management method described above in conjunction with FIGS. 1 to 8. It should be understood that the respective components or modules in the above apparatus can be implemented by hardware or by software, and can also be implemented by a combination of hardware and software.

The temperature management method for the display panel, the integrated circuit, and the display panel of the present disclosure are exemplarily described above with reference to the accompanying drawings. According to the above temperature management method of the present disclosure, by utilizing the existing hardware configuration in the display panel to perform temperature detection, not only can additional cost and complexity of the display panel be avoided, but also more accurate temperature information can be provided, such that it is beneficial to the subsequent temperature management method such as temperature compensation.

The strengths, advantages, effects, etc. mentioned in the embodiments of the present disclosure are only examples rather than limitations, and such strengths, advantages, effects, etc. cannot be considered necessary for various embodiments of the present disclosure. Additionally, the specific details as disclosed above are only for the purpose of illustration and for the purpose of easy understanding, but not for limitation. The above details do not limit that the present disclosure must be implemented with the above specific details. It is also to be pointed out that in the apparatus and method of the present disclosure, respective components or steps can be decomposed and/or recombined. Such decomposition and/or recombination should be regarded as equivalent solutions to the present disclosure.

For those ordinary operators in the art, it can be understood that all or any part of the method and device of the present disclosure can be implemented in hardware, firmware, software, or a combination thereof in any computing device (including processor, storage medium, etc.) or network of computing devices. The hardware can be a general-purpose processor, a digital signal processor (DSP), an application-specific integrated circuit (ASIC), a field programmable gate array (FPGA), or other programmable logic device (PLD), discrete gate or transistor logic, discrete hardware component, or any combination thereof that is designed to perform the functions as described herein. The general-purpose processor can be a microprocessor, but in an alternative, the processor can be any commercially available processor, controller, microcontroller, or state machine. The processor can also be implemented as a combination of computing devices, such as a combination of a DSP and a microprocessor, a plurality of microprocessors, at least one of the microprocessors cooperating with a DSP core, or any other such configuration. The software can exist in any form of computer-readable tangible storage media. By way of example and not limitation, such computer-readable tangible storage media can include RAM, ROM, EEPROM, CD-ROM or other optical disc storage, magnetic disk storage or other magnetic storage devices, or any other tangible media that can be used to carry or store desired program codes in the form of instructions or data structures and that can be accessed by a computer. As used herein, a disc includes compact disc (CD), laser disc, optical disc, digital versatile disc (DVD), floppy disc, and Blu-ray disc.

The block diagrams of elements, components, devices, apparatuses, and systems involved in the embodiments of the present disclosure are only illustrative examples and are not intended to require or imply that they must be connected, arranged, or configured in the manner as shown in the block diagrams. As those skilled in the art will recognize, such elements, components, devices, apparatuses, and systems can be connected, arranged, or configured in any way.

Additionally, the claimed scope of the present disclosure is not limited to the specific aspects of the above processing, machinery, manufacturing, composition of events, means, method, and action. The processing, machinery, manufacturing, composition of events, means, method, or action that currently exists or is to be developed later can be utilized to perform basically the same functions or achieve basically the same results as those by respective aspects as described herein.

In addition, words such as “include”, “contain”, “have” and so on are open terms, which mean “including but not limited to”, and can be used interchangeably with it. The terms “or” and “and” as used herein refer to the term “and/or”, and can be used interchangeably with it, unless otherwise indicated clearly in the context. The term “such as” as used herein refers to the phrase “such as but not limited to”, and can be used interchangeably with it.

The above description of the disclosed aspects is provided to enable any operator in the art to make or use the present disclosure. Various modifications to such aspects will be very obvious to those skilled in the art, and the general principles as defined herein can be applied to other aspects without departing from the scope of the present disclosure. Therefore, the present disclosure is not intended to be limited to the aspects as shown herein but is to be accorded the widest scope consistent with the principles and novel features as disclosed herein.

What is claimed is:

1. A temperature management method for a display panel, which is performed by a display driver integrated circuit, comprising:
detecting, by the display driver integrated circuit, an impedance value of an edge resistance line of the display panel, wherein the edge resistance line is arranged along an edge of the display panel; and
determining, by the display driver integrated circuit, temperature information of the display panel based on the impedance value of the edge resistance line.

2. The method according to claim 1, wherein the determining of the temperature information of the display panel based on the impedance value of the edge resistance line comprises:
comparing, by the display driver integrated circuit, the impedance value of the edge resistance line with a reference impedance value, wherein the reference impedance value corresponds to an impedance value of the edge resistance line detected at a reference temperature; and
determining, by the display driver integrated circuit, the temperature information of the display panel based on the comparing.

3. The method according to claim 1, wherein the determining of the temperature information of the display panel based on the impedance value of the edge resistance line comprises:
detecting, by the display driver integrated circuit, at least two impedance values of the edge resistance line at different temperatures;
determining, by the display driver integrated circuit, a temperature-impedance mapping relationship based on the at least two impedance values and their corresponding temperatures; and
determining, by the display driver integrated circuit using the determined temperature-impedance mapping relationship, the temperature information of the display panel based on the impedance value of the edge resistance line.

4. The method according to claim 1, further comprising:
performing, by the display driver integrated circuit, temperature compensation on the display panel based on the determined temperature information, wherein the temperature compensation comprises:
adjusting, by the display driver integrated circuit, at least one of parameters of the display panel based on the determined temperature information, wherein the at least one of parameters includes a source voltage V_{source}, a cathode voltage ELVSS, an anode voltage ELVDD, an initialization positive voltage VINITP, an initialization negative voltage VINITN, a high gate voltage VGH, or a low gate voltage VGL of the display panel.

5. The method according to claim 4, wherein the adjusting of the at least one of parameters of the display panel based on the determined temperature information comprises:
adjusting, by the display driver integrated circuit, the at least one of parameters using a temperature compensation curve corresponding to the determined temperature information, wherein the temperature compensation curve is determined based on at least two preset temperature compensation curves for different temperatures.

6. The method according to claim 1, further comprising:
detecting, by the display driver integrated circuit, a plurality of segmental impedance values of different segments of the edge resistance line of the display panel, wherein the different segments correspond to the different regions of the display panel;
determining, by the display driver integrated circuit, temperature information of the different regions of the display panel based on the plurality of segmental impedance values; and
performing, by the display driver integrated circuit, temperature compensation on the display panel based on the temperature information of the different regions.

7. The method according to claim 1, wherein
the temperature management method is performed periodically, comprising: performing, by the display driving integrated circuit, the temperature management method once every predetermined number of frames or predetermined time; or
the temperature management method is performed in response to an instruction from a processor.

8. An integrated circuit for a display panel, comprising:
a processing circuit; and
a memory having stored computer program instructions therein,
wherein the computer program instructions, when executed by the processing circuit, cause the integrated circuit to perform a temperature management method for the display panel, comprising:
detecting, by the integrated circuit, an impedance value of an edge resistance line of the display panel, wherein the edge resistance line is arranged along the edge of the display panel; and
determining, by the integrated circuit, temperature information of the display panel based on the impedance value of the edge resistance line.

9. The integrated circuit according to claim 8, wherein the determining of the temperature information of the display panel based on the impedance value of the edge resistance line comprises:
comparing, by the integrated circuit, the impedance value of the edge resistance line with a reference impedance value, wherein the reference impedance value corresponds to an impedance value of the edge resistance line detected at a reference temperature, and determining, by the integrated circuit, the temperature information of the display panel based on the comparing; or
detecting, by the integrated circuit, at least two impedance values of the edge resistance line at different temperatures, determining, by the integrated circuit, a temperature-impedance mapping relationship based on the at least two impedance values and their corresponding temperatures, and determining, by the integrated circuit using the determined temperature-impedance mapping relationship, the temperature information of the display panel based on the impedance value of the edge resistance line.

10. The integrated circuit according to claim 8, wherein the computer program instructions, when executed by the processing circuit, cause the integrated circuit further to:
perform temperature compensation on the display panel based on the determined temperature information, wherein the temperature compensation comprises:
adjusting, by a display driver integrated circuit, at least one of parameters of the display panel based on the determined temperature information, wherein the at least one of parameters include a source voltage V_{Source}, a cathode voltage ELVSS, an anode voltage ELVDD, an initialization positive voltage VINITP, an initialization negative voltage VINITN, a high gate voltage VGH or a low gate voltage VGL of the display panel.

11. The integrated circuit according to claim 10, wherein the adjusting of the at least one of parameters of the display panel based on the determined temperature information comprises:
adjusting, by the display driver integrated circuit, the at least one of parameters using a temperature compensation curve corresponding to the determined temperature information, wherein the temperature compensation curve is determined based on at least two preset temperature compensation curves for different temperatures.

12. A display panel, comprising:
an edge resistance line, arranged along an edge of the display panel; and
the integrated circuit according to claim 8, coupled to the edge resistance line.

13. A terminal device, comprising:
the display panel according to claim 12.

14. The terminal device according to claim 13, further comprising:
a processor, configured to receive the temperature information, and control an operation of the terminal device based on the temperature information.

15. The terminal device according to claim 14, wherein the processor controlling the operation of the terminal device based on the temperature information comprises at least one of:
power management, heat dissipation management, or processor mode management.
